(19) United States
(12) Patent Application Publication
(10) Pub. No.: US 2014/0279696 A1
(43) Pub. Date: Sep. 18, 2014

(54) ASSET DATA MANAGEMENT SYSTEM AND METHOD

(71) Applicant: Atlas Portfolio, LLC, Stillwater, MN (US)

(72) Inventors: Alexander E. Korn, Minneapolis, MN (US); Jeff Landt, New Richmond, WI (US)

(73) Assignee: Atlas Portfolio, LLC, Stillwater, MN (US)

(21) Appl. No.: 14/213,344

(22) Filed: Mar. 14, 2014

Related U.S. Application Data
(60) Provisional application No. 61/794,858, filed on Mar. 15, 2013.

(51) Int. Cl. G06Q 40/06

(52) U.S. Cl. CPC G06Q 40/06
USPC 705/36 R

(57) ABSTRACT

A financial planning and advice system that relates to asset data management and analysis, trading methodologies, and efficient transmission and storage of asset data based on user preferences for specific monetary outcomes. The system can collect information about an individual's assets and the individual's preferred asset allocation and can determine trades that, when made, will change the current asset allocation to more closely match the goal asset allocation. This information can then be exported to an external trading platform in the market.

### CROSS-REFERENCE TO RELATED APPLICATION

This application claims the benefit of U.S. Provisional Application No. 61/794,858 filed Mar. 15, 2013, titled ASSET ALLOCATION MANAGEMENT SYSTEM AND METHOD.

### FIELD

The present invention generally relates to financial planning and advice systems. More specifically, it relates to asset data management and analysis, trading methodologies and efficient transmission of asset data based on user preferences for specific monetary outcomes.

### BACKGROUND OF THE INVENTION

While advisors have been offering asset allocation advice for decades and the concept of asset location is generally understood, the service is rarely offered to clients. The reason for this is that, without a framework, most advisors find it exceedingly difficult to mentally determine the best mix of assets. The interrelatedness of accounts and the underlying calculations creates a nearly infinite number of possibilities. Additionally, the process of asset allocation is typically manual and, thus, inefficient. For this reason, such asset allocation is not profitable for most financial advisors or cost-effective for most clients. For these reasons, one finds that very few advisors offer the service of asset allocation advice.

### BRIEF SUMMARY OF THE INVENTION

Generally, the disclosed system and method include a novel computer-implemented system and method for managing, tracking, and communicating investment management activities, specifically, determining how to optimally arrange the assets in any number of potentially disparate accounts (e.g. IRA, 401(k), Roth IRA, annuity) so that they work together to construct the global asset allocation model recommended by a financial advisor. This process is accomplished by evaluating the possible trades necessary across multiple accounts using a min-cost, max-flow network flow algorithm and by taking into account asset location preferences, tax consequences, and more. The ability to assign preferences to any particular asset class in any available account greatly increases the speed with which an advisor can determine the optimal portfolio from an asset location standpoint.

The system can, through secure data connections, manage and store individual investment account information at the asset allocation level and connect with separate trading applications to execute the desired allocations. This separation of functions allows for automation of asset allocation with appropriate shields from trading activities, which are separately managed. Further, the system allows for more efficient data management and storage as related to complex financial transaction and performance information.

The system and method described herein are implemented in computer hardware described later in this document. Software is employed to manage user interface, the movement of data from user to database and reverse. Further, software is employed to connect and allow for information to move between the investment asset allocation system and software and the trading system and software.

### BRIEF DESCRIPTION OF THE DRAWINGS

FIG. 1 is a flowchart illustrating an example use of the trading process of the present invention.

FIG. 2 is a flowchart illustrating the process that occurs to input data, calculate a trade, and export data.

FIG. 3 is an exemplary illustration of setting the current holdings of a portfolio, according to one embodiment of the present invention.

FIG. 4 is an exemplary illustration of an overall asset allocation change, according to one embodiment of the present invention.

FIG. 5A is an exemplary illustration of setting preferences for a single account, according to one embodiment of the present invention.

FIG. 5B is an exemplary illustration of setting preferences for a single account, according to one embodiment of the present invention.

FIG. 6 is an exemplary illustration of trades to be executed, according to one embodiment of the present invention.

FIG. 7 illustrates a flow network used in one embodiment of the present invention.

FIG. 8 is a schematic block diagram of an example computing system that may be used in accordance with one embodiment of the present invention.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

### DEFINITIONS

The following are a list of terms and their descriptions. They are meant to provide additional information regarding the present invention, but do not delimit the full scope of the invention.

Asset allocation: There are many widely-recognized asset types utilized in model portfolio theory, such as Large Cap Growth, Small Cap Value, Real Estate, Cash, etc. An asset allocation defines how much of each of these assets is contained within a certain portfolio or account.

Overall asset allocation (“overall allocation”): The asset allocation for the client's full portfolio, which may be contained within several different accounts.

Account: May be referred to as, for example, His IRA, Her IRA, Roth.

Account asset allocation (“account allocation”): The asset allocation for one specific account.

User: The user of the disclosed system, usually a financial advisor (sometimes referred to as “advisor” below).

Client: Often, but not always, a couple. Referred to as “client” below.

### DESCRIPTION

FIG. 1 is a flowchart illustrating use of the trading algorithm disclosed herein according to one embodiment of the invention. A user can input individual investor's beginning asset allocation, a target allocation 106, and various preferences 104 into the system. Beginning asset allocation is set by an investor's current holdings, which are imported 110 into the disclosed system's algorithm 102. Target allocation 106 can be defined in a number of ways and is inputted 114 into the disclosed system's algorithm 102. The system then creates a trade, which is a set of asset or fund buy/sells that will change the current allocation to more closely match the intended target allocation 106. A trade is exported 112 by the system to an external trading platform 108 in the market.

After having decided upon a target overall allocation 106 for a client, a user, usually a financial advisor, will need to implement the overall allocation within the client's accounts using the process depicted in FIG. 2. For example, a user can input an individual investor's current holdings from an external trading system 202. Then, the user can set preferences 204, such as asset location and required minimum distributions (RMDs), construct a flow network 206, assign weights to flow network edges 208, run a min-cost, max-flow algorithm 210, get asset trades from appropriate flow network edges 212, when necessary, assign asset trades to fund trades 214, and export trades into an external trading system 216. The summation of all of the client's account allocations is equal to the overall allocation. The accounts have a current target allocation 106 that can be inputted into the disclosed system 114.

FIG. 3 illustrates one example of how to set the current holdings of the portfolio 202 with each column containing information for a single account within the portfolio 202. For example, a user can upload and import fund holdings by selecting a browse option 302 within the system and then selecting the upload button 304. Funds can be uploaded to specific internal 306 or external 308 accounts. An internal account 306 is one where a user can order-blast trades into specific funds and pull holdings automatically from a trading program used by financial advisors. An external account 308 is an account that a user cannot control or access directly, such as, but not limited to, a 401k sponsored by the client's employer. When importing holdings, a user can key in each holding, asset by asset, into whichever account the holdings belong to. Examples of assets that the system can support include, but are not limited to, cash, bonds (high yield bonds, international bonds, domestic bonds, etc.), and equities (natural resources/commodities, real estate, emerging markets, international small cap, international large cap, small cap value, small cap growth, large cap value, large cap growth, etc.). A user can view all current accounts at once and can save any recently inputted assets or accounts by selecting a save button 310. Alternatively, a user can proceed without saving any recently inputted assets or accounts by selecting a cancel button 312.

The most simplistic way of calculating the target allocation of the accounts as a whole is to have each account hold the same proportional allocation as the overall portfolio. So, for example, if the overall portfolio is $1 million and needs $150 k in cash, an account with $100 k should have $15 k in cash. In one embodiment of an overall asset allocation, as illustrated in FIG. 4, the difference in asset allocation before a trade and after a trade is illustrated graphically using an inner circle 402 and outer circle 404, wherein each piece of the inner circle 402 represents the amount and percentage of that asset in the account before the trade and each piece of the outer circle 404 represents the amount and percentage of that asset in the account after the trade. In one embodiment of an overall asset allocation, also illustrated in FIG. 4, the updated value of asset allocation after a trade is illustrated by a chart. The chart can include information such as, but not limited to, asset type 406, amount to be traded of each asset 408, what the holdings will be for each asset after the trade 410, and what percentage of the portfolio the asset will comprise after the trade 412.

However, advisors will often want to favor or disfavor certain asset classes within each account. This practice is known as asset location. For example, certain asset classes may not be available in an account, or an advisor may want to more heavily weight Real Estate in a tax-deferred or qualified account because REITs (Real Estate Investment Trusts) create more dividends, which would result in an income tax liability for the client. Locating the necessary REIT holding within a tax-deferred account reduces current taxation and increases overall levels of wealth. In general it is desirable to place tax inefficient assets (e.g. foreign bonds, REITs, commodities) into tax-sheltered accounts and place tax efficient assets (e.g. index mutual funds, exchange traded funds [EFTs], growth orientated investments) into brokerage or non-qualified accounts.

The process of asset location can be computationally difficult. Imagine, in the example above, that the advisor wanted to more heavily weight cash to $25 k instead of $15 k. The advisor would have to reduce the weighting of the other asset types in that account (because that account still needs to hold $100 k), then reduce the weighting of cash in the other accounts (so we still have $150 k in cash total), and then increase the weighting of the other asset classes in the other accounts so that their overall values are still correct.

For example, below are two different possible ways of allocating two asset classes across three accounts:

| | | Account A | Account B | Account C | Total Required |
|---|---|---|---|---|---|
| Option 1 | Cash | $25,000 | $50,000 | $75,000 | $150,000 |
| | Stocks | $50,000 | $75,000 | $100,000 | $225,000 |
| | | $75,000 | $125,000 | $175,000 | $375,000 |
| Option 2 | Cash | $5,000 | $100,000 | $45,000 | $150,000 |
| | Stocks | $70,000 | $25,000 | $130,000 | $225,000 |
| | | $75,000 | $125,000 | $175,000 | $375,000 |

The complexity of determining how to develop the optimal asset mix increases geometrically as you add assets classes and accounts. It also increases as you add other considerations, such as minimizing the amount that is traded within each account or taking into account certain accounts that have required holdings of a certain asset class.

The disclosed asset allocation management system allows advisors to give each asset within each account a high or low “preference” 502. For example, an advisor can assign a number between zero and ten wherein a five is the default, a zero indicates that that asset is not available in that account, a one means to heavily disfavor that asset, and a ten means to heavily favor it. Using these preferences, the system can create an allocation for each account such that the asset location preferences are followed, accounts hold the correct total value, and the overall allocation is correct. FIGS. 5A and B illustrates one example of setting preferences for a single account.

In one embodiment, as illustrated in FIG. 5A, the user can use a mapping 504 option. This option allows a user to allocate the proportion of an unavailable asset class to a separate proxy asset class. For example, if international bonds are not an available asset class option in a 401k plan, the user may move the proportion allocated to international bonds to domestic bonds.

In one embodiment, as illustrated in FIG. 5B, the user can set up other account information such as, but not limited to, the account type, the date the account is available, the account number, the selected funds to make changes to, the fund or funds to ignore, whether there is a minimum cash requirement or preference, the tradability 506, an amount, if any, for a required deposit 508, and transfer to/close preferences 510.

Tradability 506 refers to the extent to which the user will allow “churn” to occur within a certain account due to tax consequences of those trades. For example, a user may want to avoid trading within a taxable 401k, but would be fine with trading within a non-taxed Roth and would therefore set tradability to be higher in the non-taxed Roth and lower in the taxable 401k.

Buying and selling assets at the same time is called “churn”. When changing the overall allocation in an account, often there is no net liquidation of assets. For example, $10,000 of Domestic Bonds may need to be sold so that $10,000 of Large Cap Growth can be bought. Non-Qualified accounts are taxed when funds within them are liquidated. Therefore, in this situation, taxes might need to be paid on the Domestic Bonds, but there would be no net liquidation to cover these taxes. Therefore, the disclosed system will attempt to not churn within Non-Qualified accounts to avoid unnecessary tax consequences for the client. It will instead try to make all churn trades within a tax-deferred or Qualified account.

The required deposit 508 function permits money to be added or removed from an account. For example, if there is a Required Minimum Distribution (RMD) of $10,000, the user can input $10,000 is the required deposit section. Accounts often have an RMD when someone reaches a certain age, which indicates that a certain amount of money must be pulled out of an account. In one embodiment, the disclosed system will always execute an RMD before trying to satisfy other constraints. FIG. 6 illustrates an example of a set of trades to be executed for two separate accounts. Each trade displays the asset type 602 to be traded, the ticker 604 number, and the amount of the trade 606. In one embodiment of the disclosed system, sets of trades can be exported into a spreadsheet form by clicking an export internal 608 button or they can be printed out by click a printout 610 button.

The transfer to/close 510 selection refers to an action to take on the overall account. “Transfer to” is used when rolling one account over into another. “Close” is used when closing an account.

The disclosed system will follow all of the above rules, attempting to create the “best” trade across all of the accounts, taking into consideration information such as, but not limited to, asset location preferences, RMDs, and the tax status of the account.

Generally, the disclosed system formulates the above problems as a min-cost, max-flow network flow problem. However, instead of water flowing through pipes, money is flowing into different asset types in different accounts. As illustrated in FIG. 7, money starts at the leftmost node 702, which represents the “source”, and it flows through a series of allocations 706 and trades 708, which are determined by asset location preferences 710 and target asset allocation 712, to its final “sink” destination at the rightmost node 704.

FIG. 7 illustrates an example where a client has five asset classes and three accounts, although other graphs can have fewer or more asset classes and any number of accounts. The top set of nodes represents Account 1 714. Each of the five nodes within Account 1 714 represents one asset within Account 1 714, as illustrated by the smallest box surrounding the topmost row of nodes in FIG. 7. Each row of nodes in the graph, thereafter, represents a separate account. In the top group, all five assets belong to Account 1 714. In the middle and bottom groups, the five assets in each belong to a second and third account, respectively.

The max-flow part of the algorithm ensures that the entire portfolio can be allocated and it comes up with one possible allocation of the assets across the different accounts. Certain setups are impossible to satisfy, such as one where every account has Domestic Bonds set as preference zero, but the overall portfolio requires some Domestic Bonds. The max flow part of the algorithm can detect this.

The min-cost part of the algorithm is used to find the optimal way to allocate the assets. A higher preference number on an account-asset reduces the cost of its pipes, encouraging the system to allocate more toward that account-asset. Similarly, RMDs are represented by edges with an extremely negative weight, which forces the system to satisfy the RMD above all else.

The ability to assign preferences to any particular asset class in any available account greatly increases the speed with which an advisor can determine the optimal portfolio from an asset location standpoint. With the algorithm and interface provided, advisors can determine the optimal location of each asset class while honoring the overall asset allocation between any number of accounts the client may own in seconds.

The preferences and results of each trade are stored in the system for the full life of the portfolio so that they can be referred back to in order to track the history of the portfolio.

The disclosed system and method interacts with the external trading system by importing and exporting spreadsheets (CSV files). With this system, advisors are able to review all trades before they are actually implemented, which provides an additional security and quality benefit for the client.

The disclosed invention involves technology that uses a computing system. FIG. 8 is a schematic block diagram of an example computing system 800. The invention includes at least one computing device 802. In some embodiments the computing system further includes a communication network 804 and one or more additional computing devices 806 (such as a server).

Computing device 802 can be, for example, located in a place of business or can be a computing device located in a user's home or office. In some embodiments, computing device 802 is a mobile device. Computing device 802 can be a stand-alone computing device or a networked computing device that communicates with one or more other computing devices 806 across a network 804. The additional computing device(s) 806 can be, for example, located remotely from the first computing device 802, but configured for data communication with the first computing device 802 across a network 804.

In some examples, the computing devices 802 and 806 include at least one processor or processing unit 808 and system memory 812. The processor 808 is a device configured to process a set of instructions. In some embodiments, system memory 812 may be a component of processor 808; in other embodiments system memory is separate from the processor. Depending on the exact configuration and type of computing device, the system memory 812 may be volatile (such as RAM), non-volatile (such as ROM, flash memory, etc.) or some combination of the two. System memory 812 typically includes an operating system 818 suitable for controlling the operation of the computing device, such as the Linux operating system. The system memory 812 may also include one or more software applications 814 and may include program data 816.

The computing device may have additional features or functionality. For example, the device may also include additional data storage devices 810 (removable and/or non-removable) such as, for example, magnetic disks, optical disks, or tape. Computer storage media 810 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices 802, 806 can be located in a financial planner's place of business. In other examples, the computing device can be a personal computing device that is networked to allow the user to access the present invention at a remote location, such as in a user's home, office or other location. In some embodiments, the computing device 802 is a smart phone, tablet, laptop computer, personal digital assistant, or other mobile computing device. In some embodiments the invention is stored as data instructions for a smart phone application. A network 804 facilitates communication between the computing device 802 and one or more servers, such as an additional computing device 806, that host the system. The network 804 may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 806 is a Web server. In this example, the first computing device 802 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of the computing devices 802 and 806, the instructions cause the processor to perform one or more of the operations or methods disclosed herein. Examples of operations include communication between or among users; task list and order set management; dashboard functions; the storage of account information for multiple users; and other operations.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

We claim:

1. A method of managing and analyzing asset data comprising:
utilizing a networked computing device having a processing device and a memory device, the memory device storing information that, when executed by the processing device, causes the processing device to:
collect information from a user about a client's current assets;
collect information from a user about the client's preferred asset allocation;
store the collected asset information in an account affiliated with the client;
use the collected information to recommend asset trades to the user based on the client's preferred asset allocation; and
export the recommended asset trades to an external trading platform.

2. The method of claim 1, wherein the account affiliated with the client is an internal account.

3. The method of claim 1, wherein the account affiliated with the client is an external account.

4. The method of claim 1, wherein the processing device can minimize the amount of assets to be traded within the account.

5. The method of claim 1, wherein the processing device can enable a user to favor an asset within the account so that the asset is more likely to be traded.

6. The method of claim 1, wherein the processing device can enable a user to disfavor an asset within the account so that the asset is less likely to be traded.

7. The method of claim 1, wherein the processing device can enable a user to move the proportion allocated for one asset class in the account to a second, proxy asset class.

8. The method of claim 1, wherein the processing device can collect information about the account's required minimum distributions.

9. The method of claim 1, wherein the processing device can collect and store the results of any trade that is executed on an external trading platform.
